(19) United States
(12) Patent Application Publication
(10) Pub. No.: US 2005/0142351 A1
(43) Pub. Date: Jun. 30, 2005

(54) Toner fixing belt

(75) Inventors: Masao Takagi, Numazu-shi (JP); Goki Inukai, Kuki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO KOGYO CO., LTD, Tokyo (JP)

(21) Appl. No.: 11/017,009

(22) Filed: Dec. 21, 2004

(30) Foreign Application Priority Data
Dec. 25, 2003 (JP) 2003-429666

(51) Int. Cl. B32B 5/16

(52) U.S. Cl. 428/323; 399/320; 399/333; 428/411.1

(57) ABSTRACT

A fixing belt for fixing a toner image on a transfer medium is provided with an-endless belt body formed of electroformed nickel composed of crystallites oriented on crystal orientation planes. With respect to those crystallites on the crystal plain which have average grain diameter greatly changed by heating, a change ratio of average grain diameter after heating at 250° C. for 2 hours is not larger than 110% based on average grain diameter before heating.

### CROSS-REFERENCE TO RELATED APPLICATIONS

This application is based upon and claims the benefit of priority from prior Japanese Patent Application No. 2003-429666, filed Dec. 25, 2003, the entire contents of which are incorporated herein by reference.

### BACKGROUND OF THE INVENTION

1. Field of the Invention

The present invention relates to a toner fixing belt having an endless belt body formed of electro-formed nickel, used in the fixing portion of an image forming apparatus such as a facsimile machine or a laser beam printer.

2. Description of the Related Art

In an image forming apparatus such as a facsimile machine or a laser beam printer, a belt fixing system using an endless fixing belt has come to be employed in place of a fixing roller, in order to achieve, for example, miniaturization, energy saving, and improvement in printing or copying speed. The fixing belt is thin so that the entire region of the fixing belt can be heated quickly, thereby markedly shortening the waiting time after turning on the power.

It is known in the art that an endless nickel belt body formed of electroformed nickel is used as the belt body of the fixing belt, as disclosed in, for example, Japanese Patent Disclosure (Kokai) No. 2002-148975. In the electroforming method, an electrodeposition is carried out using a nickel electrodepositing bath on the surface of a mandrel, e.g., a cylindrical stainless steel mandrel, which is used as a cathode, so as to form an electrodeposited nickel film. The electrode-posited nickel film thus formed is peeled off the surface of the mandrel so as to obtain a product base body of the fixing belt.

The patent document quoted above teaches that an endless nickel belt body containing carbon in an amount of 0.01 to 0.1 mass % is prepared by the electroforming method. In contrast, Japanese Patent Disclosure (Kokai) No. 2003-57981 teaches a belt fixing system using a halogen lamp as a heat source.

However, the conventional fixing belt having an electroformed nickel belt body fails to exhibit sufficient resistance to thermal fatigue at high temperatures and, thus, is poor in durability. More specifically, the conventional fixing belt formed of electroformed nickel gives rise to the problem that cracks occur in the fixing belt through repeated use of the fixing belt at high temperatures, breaking the belt body.

### BRIEF SUMMARY OF THE INVENTION

An object of the present invention is to provide a toner fixing belt of a high durability, in which the resistance of the fixing belt to thermal fatigue at high temperatures is improved.

The present inventors have conducted crystallo-graphic research into an electroformed nickel belt body of a toner fixing belt used at high temperatures. As a result, it has been found that, among the crystallites constituting the electroformed nickel belt body, crystallites oriented on a specified crystal plane, e.g., crystallites oriented on the (111) plane on the rear surface of the belt body, grow relatively large through heating at high temperatures, causing breakage of the belt body at high temperatures. Thus, the present inventors have succeeded in manufacturing a toner fixing belt comprising a belt body having high resistance to thermal fatigue at high temperatures by employing the measures given below.

According to a first aspect of the present invention, there is provided a fixing belt for fixing a toner image on a transfer medium, comprising an endless belt body formed of electroformed nickel comprising crystallites oriented on crystal orientation planes, wherein, with respect to those crystallites on the crystal plain which have average grain diameter greatly changed by heating, a change ratio of average grain diameter after heating at 250° C. for 2 hours is not larger than 110% based on average grain diameter before heating.

According to a second aspect of the present invention, there is provided a fixing belt for fixing a toner image on a transfer medium, comprising an endless belt body formed of electroformed nickel comprising crystallites oriented on crystal orientation planes, wherein, with respect to those crystallites on the crystal orientation plain which have average grain diameter greatly changed by heating, a difference in average grain diameter after heating at 250° C. for 2 hours and that before heating is suppressed to 220 Å or less.

In the toner fixing belt of the present invention, the belt body preferably contains a crystal growth suppressing agent selected from the group consisting of phosphorus, manganese and boron.

In the present invention, the rear surface of the belt body represents the inner circumferential surface of the belt body and the front surface of the belt body represents the outer circumferential surface of the belt body.

### BRIEF DESCRIPTION OF THE SEVERAL VIEWS OF THE DRAWING

FIG. 1 is a front view illustrating a fixing belt according to an embodiment of the present invention; and

FIG. 2 is an enlarged view illustrating a portion of the cross section taken along the line II-II of FIG. 1.

### DETAILED DESCRIPTION OF THE INVENTION

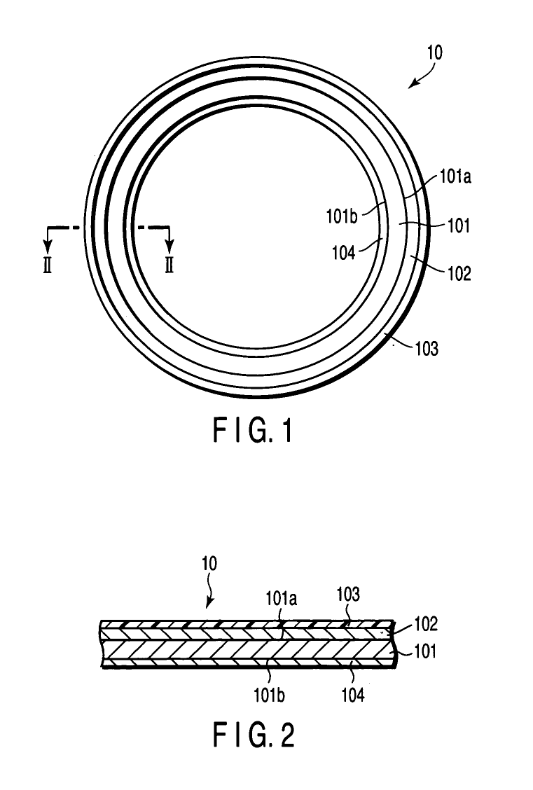

FIG. 1 is a front view schematically illustrating a toner fixing belt 10 according to an embodiment of the present invention, and FIG. 2 is an enlarged view illustrating a portion of the cross section taken along the line II-II shown in FIG. 1.

The fixing belt 10 comprises an endless belt body 101 formed of electroformed nickel. As shown in FIGS. 1 and 2, the fixing belt 10 usually has a releasing layer 103 such as a fluororesin layer coated, directly or through an elastic layer 102 such as a silicone rubber layer, on the front surface (outer circumferential surface). On the rear surface (inner circumferential surface) of the belt body 101, a sliding layer 104 may formed, as required, to improve the sliding properties. A primer layer (not illustrated) may be provided between the belt body 101 and the elastic layer 102, between the elastic layer 102 and the releasing layer 103, or between the belt body 101 and the sliding layer 104, for securing the bonding between the adjacent layers of the fixing belt 10. Use may be made of a known material such as a silicone material, an epoxy material, or a polyamideimide material for forming the primer layer. The thickness of the primer layer may be about 1 μm to 30 μm.

In the case of employing an electromagnetic induction heating system, it is desirable that the thickness of the belt body 101 is larger than the skin depth represented by the formula:
σ=503×(ρ/fμ)^{1/2}
where σ denotes the skin depth (m), f denotes the frequency (Hz) of the exciting circuit, μ denotes the permeability, and ρ denotes the resistivity (Ωm). The thickness of the belt body 1 is preferably 1 μm to 100 μm. The skin depth represents the absorption depth of the electromagnetic wave used for the electromagnetic induction heating. The intensity of the electromagnetic wave in the portion deeper than the skin depth becomes 1/e or less and, thus, almost all the energy is absorbed before reaching the skin depth. If the thickness of the belt body is smaller than 1 μm, the belt body fails to absorb almost all the electromagnetic energy so as to lower the efficiency. On the other hand, if the thickness of the belt body 101 exceeds 100 μm, the rigidity of the belt increases, and the flexibility is lowered. It follows that the flexing properties of the belt body tend to be impaired, with the result that the belt body is rendered unsuitable for use in the fixing belt.

On the other hand, where the belt is used in a belt fixing system using a halogen heater as a heating source, the thickness of the belt body 101 is usually 10 μm to 100 μm, preferably 15 μm to 80 μm, and more preferably 20 μm to 60 μm in order to decrease the heat capacity of the fixing belt, improving the quick starting properties. The thickness of the belt body is most preferably 30 μm to 50 μm in view of the balance among, for example, the heat capacity, the heat conductivity, the mechanical strength, and the flexibility. Where the belt body is used in a fixing belt for an electrophotographic copying machine, the width of the belt body may be determined appropriately in accordance with the width of a recording medium such as recording paper sheet.

The electroformed nickel belt body 101 contains a large number of crystallites. With respect to those crystallites on the crystal plain which have average grain diameter greatly changed by heating, a change ratio of average grain diameter after heating at 250° C. for 2 hours is not larger than 110% based on average grain diameter before heating, according to a first aspect of the invention. The change ratio of average grain diameter is calculated by the equation:
Change ratio (%)=(A−B)/B×100
where A denotes the average grain diameter after heating, and B denotes the average grain diameter before heating.

According to a second aspect, from the point of view of the degree of change in the average grain diameter of the crystallites constituting the electroformed nickel belt body 101, a difference in average grain diameter after heating at 250° C. for 2 hours and that before heating is suppressed to 220 Å or less with respect to those crystallites on the crystal orientation plain which have average grain diameter greatly changed by heating.

The unheated state or the state before heating, which is referred to in the present specification, denotes the state that the belt body is put under ambient temperature. The temperature under which the belt body is put after preparation of the belt body by the electroforming method until the toner fixing belt is manufactured using the belt body is included in the ambient temperature. In general, the ambient temperature denotes a temperature up to 100° C.

In general, in the present invention, the electro-formed nickel belt body 101 may formed of crystallites having an average grain diameter of 130 to 250 Å in the unheated state.

The crystallites that are oriented on a plurality of specified crystal orientation planes are present on the front surface and the rear surface of the electroformed nickel belt body 101. For example, the crystallites constituting the electroformed nickel belt body can be mainly composed of crystallites that are oriented on the (111) plane on the front surface (hereinafter referred to as “front surface (111) crystallite”), crystallites that are oriented on the (111) plane on the rear surface (hereinafter referred to as “rear surface (111) crystallite”), crystallites that are oriented on the (200) plane on the front surface (hereinafter referred to as “front surface (200) crystallite”), and crystallites that are oriented on the (200) plane on the rear surface (hereinafter referred to as “rear surface (200) crystallite”). It has been found that if, of the crystallites constituting the electroformed nickel belt body, crystallites having an average grain diameter most greatly changed by heating (for example, heating at 250° C. for 2 hours) or having the highest change ratio of the average grain diameter caused by such heating and oriented on the crystal orienting plane are suppressed in the grain growth caused by heating, it is possible to improve significantly the resistance of the belt body 101 to thermal fatigue. More specifically, if the grain growth caused by heating of the particular crystallites is suppressed, a number of repetitions not smaller than 300,000, preferably not smaller than 500,000, and more preferably not smaller than 1,000,000, can be achieved in the thermal fatigue resistance test described in the following, demonstrating that the belt body 101 exhibits a thermal fatigue resistance sufficiently high for putting the belt body 101 to the practical use. The change ratio of the average grain diameter of the particular crystallites caused by heating is preferably not higher than 60%. Also, the change in the average grain diameter of the particular crystallites caused by heating is preferably not larger than 200 Å, more preferably not larger than 110 Å.

Needless to say, the average grain diameter of the crystallites oriented on each of the crystal orienting planes can be measured by means of an X-ray diffraction apparatus. The average grain diameter of the crystallites can also be obtained by means of commercially available analytical software.

In the electroformed nickel belt body composed of the front surface (111) crystallites, rear surface (111) crystallites, front surface (200) crystallites, and rear surface (200) crystallites, the rear surface (111) crystallites constitute the crystallites having a grain diameter most greatly changed by heating or having the highest change ratio of the grain diameter caused by heating. Needless to say, the selection of the crystallites having the greatest change and the highest change ratio caused by heating can also be applied to the electroformed nickel belt body and having the other crystal orientation planes.

The mechanism for improving the thermal fatigue resistance of the belt body achieved in the present invention has not yet been clarified sufficiently. However, the belt body of the present invention can contain carbon in an amount of 0.05 to 0.08 mass %. Also, the belt body of the present invention may contain sulfur in an amount of 0.003 to 0.008 mass %.

Generally, the belt body 101 can be prepared by an electroforming method using a nickel electrodepositing bath, such as a Watts bath containing nickel sulfate or nickel chloride as a main component, or a sulfamate bath containing nickel sulfamate as a main component. Electroforming is a process in which a relatively thick metal film is electrodeposited over the surface of a mandrel, followed by detaching the electrodeposited film from the mandrel so as to obtain a desired article of the belt body. Thus, the rear surface (inner circumferential surface) 101b of the belt body 101 is the surface that is brought into contact with the mandrel.

To obtain the belt body 101, a cylinder made of, e.g., stainless steel, brass or aluminum may be used as the mandrel, and an electrodeposited nickel film can be formed over the surface of the cylinder, using a nickel electrodepositing bath. Where the mandrel is formed of a nonconductive material such as a silicone resin or gypsum, electric conductivity may be imparted thereto by using graphite, a copper powder, or silver mirror, or by employing a sputtering method. Where electroforming is conducted on a metal mandrel, it is desirable to apply a detachment-facilitating treatment to the mandrel by forming a releasing film such as an oxide film, a compound film or a coated film of a graphite powder on the surface of the mandrel, in order to facilitate the detachment of the electroformed nickel film from the mandrel.

The nickel electrodepositing bath contains a nickel ion source, an anode dissolving agent, a pH buffering agent and other additives. The nickel ion source includes, for example, nickel sulfamate, nickel sulfate and nickel chloride. In the case of a Watts bath, nickel chloride acts as the anode dissolving agent. In the case of other nickel electrodepositing baths, ammonium chloride or nickel bromide, for example, is used as the anode dissolving agent. The nickel electrodeposition is usually carried out at a pH value of 3.0 to 6.2. In order to set the pH at a desired value within the range noted above, a pH buffering agent such as boric acid, formic acid or nickel acetate is used. The other additives include, for example, a brightener, a pit preventing agent and an internal stress reducing agent, which are intended to achieve the smoothening, the pit prevention, the formation of fine crystals, and the reduction of the residual stress.

It is desirable to use a nickel sulfamate bath as the nickel electrodepositing bath. As an example, the sulfamate bath may contain 300 to 600 g/L of nickel sulfamate tetrahydrate, 0 to 30 g/L of nickel chloride, 20 to 40 g/L of boric acid, an appropriate amount of a surfactant, and an appropriate amount of a brightener (a primary brightener and a secondary brightener). The primary brightener includes, for example, trisodium naphthalene-1,3,6-trisulfonate, which also acts as a sulfur supply source for supplying sulfur into the electroformed nickel. The secondary brightener includes, for example, 2-butyne-1,4-diol, which also acts as a carbon supply source for supplying carbon into the electroformed nickel. The pH value of the sulfamate bath is desirably set at 3.5 to 4.5. The temperature of the sulfamate bath is desirably set at 40 to 60° C. Further, the current density is desirably set at 0.5 to 15 A/dm². In the case of a high concentration bath, the current density is desirably set at 3 to 40 A/dm².

According to one embodiment of the present invention, the electroforming operation is carried out under the conditions noted above by adding a supply source of phosphorus, boron and/or manganese to the nickel electrodepositing bath, particularly, to the nickel sulfamate bath described above. In this case, it has been found that the grain growth of the crystallites caused by heating can be suppressed more effectively, regardless of the sulfur content or the carbon content of the electroformed nickel. Thus, phosphorus, boron and/or manganese acts as a crystal growth suppressing agent of the crystallites. When the electroforming operation is carried out by using a nickel electrodepositing bath, particularly the sulfamate bath, containing phosphorus, boron and/or manganese, a larger amount of phosphorus, boron and/or manganese is taken into the nickel skin film deposited in the initial stage on the surface of the mandrel, and the phosphorus, boron and/or manganese content is rendered correspondingly low in the nickel skin film precipitated later, though the detailed mechanism of the this phenomenon has not yet been clarified. As a result, the grain growth of the crystallites oriented, particularly, on the (111) plane on the rear surface of the resultant belt body is suppressed so as to improve the thermal fatigue resistance properties.

Phosphorus can be co-precipitated with nickel by adding phosphorus in the form of a water soluble salt of a phosphorus-containing acid, such as sodium hypophosphite, to the nickel electrodepositing bath. Boron can be co-precipitated with nickel by adding boron in the form of a water-soluble organic boron compound, such as trimethyl amine borane, to the nickel electrodepositing bath. Further, manganese can be co-precipitated with nickel by adding manganese in the form of a water-soluble manganese compound, such as manganese sulfate tetrahydrate, to the nickel electrodepositing bath. Note that boric acid does not act as a supply source of boron to the electroformed nickel. The electroformed nickel belt body of the invention contains phosphorus preferably in an amount of smaller than 0.4 mass %. Usually, the phosphorus content is not lower than 0.04 mass %. Also, the electroformed nickel belt body contains boron preferably in an amount of 0.001 to 0.02 mass %. Further, the electroformed nickel belt body contains manganese preferably in an amount of 0.04 to 0.5 mass %.

The toner fixing belt may be heated to 200° C. or higher. The heating temperature of 250° C. that is considered in the present invention is the temperature including an allowance with respect to the temperature of 200° C. noted above.

As described previously, it has been found according to the present invention that when the change ratio of the average grain diameter after heating at 250° C. for 2 hours based on the average grain diameter before heating is suppressed to not higher than 110% in respect of the crystallites having an average grain diameter greatly changed by heating, the thermal fatigue resistance of the electroformed nickel belt body is remarkably improved. Thus, it can be said that toner fixing belts excellent in its thermal fatigue resistance can be manufactured with high stability by preparing electroformed nickel belt bodies, measuring the average grain diameters of these belt bodies, selecting belt bodies whose change ratio of the average grain diameter of crystallites having average grain diameter greatly changed by heating is calculated to be not larger than 110%, and preparing toner fixing belts using the thus selected belt bodies. Likewise, toner fixing belts excellent in its thermal fatigue resistance properties can be manufactured with high stability by selecting and using belt bodies whose change in average grain diameter of the particular crystallites referred to above is not larger than 220 Å.

The present invention will now be described with reference to Examples, though the present invention is not limited by the following Examples.

### EXAMPLE 1

An aqueous solution containing 500 g/L of nickel sulfamate tetrahydrate and 35 g/L of boric acid was prepared and put in a container loaded with an activated carbon. Then, electrolytic refining was carried out at a low current while filtering the aqueous solution by using a 0.5 μm filter. Then, the activated carbon was taken out and a required amount of a pit preventing agent was added to the aqueous solution. Thereafter, 0.1 g/L of trisodium naphthalene-1,3,6-trisulfonate as a primary brightener, and 25 mg/L of 2-butyne-1,4-diol as a secondary brightener were added, preparing a desired sulfamate bath (electrolytic bath) (see Table 1 below).

Electroforming was performed at a prescribed bath temperature by using the above electrolytic bath with a stainless steel cylindrical mandrel having an outer diameter of 34 mm used as a cathode, at a current density of 10.5 A/dm², thus forming an electrodeposited film having a thickness of 50 μm on the outer circumferential surface of the mandrel. After washed with a deionized water, the electrodeposited film was detached from the mandrel, providing an electroformed nickel belt body having an inner diameter of 34 mm and a thickness of 50 μm.

### EXAMPLES 2 to 10

Electroformed nickel belt bodies were manufactured as in Example 1, except that sulfamate bathes having the compositions shown in Table 1 were used.

The sulfur content (mass %) and the carbon content (mass %) were measured by the combustion-infrared ray absorption method in respect of the electroformed nickel belt body of each of Examples 1 to 10. Table 1 also shows the results.

### EXAMPLES 11 to 20

Electroformed nickel belt bodies were manufactured as in Example 1, except that sulfamate bath containing 500 g/L of nickel sulfamate tetrahydrate, 35 g/L of boric acid, 0.3 g/L of the primary brightener used in Example 1, and 140 mg/L of the secondary brightener used in Example 1 as shown in Table 2. Also, sodium hypophosphite monohydrate was added as a phosphorus source to the sulfamate bath in each of Examples 11 to 14, trimethyl amine borane was added as a boron source to the sulfamate bath in each of Examples 15 to 17, and manganese sulfamate tetrahydrate was added as a manganese source to the sulfamate bath in each of Examples 18 to 20.

The phosphorus content (mass %) and the boron content (mass %) were measured by means of an ICP emission spectrometer, and the manganese content (mass %) was measured by means of an atomic absorption spectrophotometer in respect of the electroformed nickel belt body in each of Examples 11 to 20. Incidentally, the sulfur content (mass %) and the carbon content (mass %) were also measured in respect of the electroformed nickel belt body of each of Examples 11 to 20. Table 2 also shows the results.

TABLE 1
Composition of Sulfamate Bath and Content of Sulfur and Carbon of Belt Body

| | | | | | | | Content of | |
|---|---|---|---|---|---|---|---|---|
| | | Composition of Sulfamate Bath | | | | | Sulfur and | |
| | | Nickel | | | | | Carbon of | |
| | | Sulfamate | Boric | Primary | Secondary | | Belt Body | |
| Example | Remarks | tetrahydrate | Acid | Brightener | Brightener | | Sulfur | Carbon |
| 1 | Comp. Ex. | 500 g/L | 35 g/L | 0.1 g/L | 25 | mg/L | 0.0019 | 0.01 |
| 2 | | | | | 50 | mg/L | | 0.02 |
| 3 | | | | | 75 | mg/L | | 0.03 |
| 4 | | | | | 100 | mg/L | | 0.04 |
| 5 | | | | 0.3 g/L | 75 | mg/L | 0.0055 | 0.03 |
| 6 | The | 500 g/L | 35 g/L | 0.3 g/L | 150 | mg/L | 0.0055 | 0.05 |
| 7 | invention | | | | 225 | mg/L | | 0.07 |
| 8 | | | | 0.5 g/L | 150 | mg/L | 0.0074 | 0.05 |
| 9 | | | | | 200 | mg/L | | 0.07 |
| 10 | | | | | 250 | mg/L | | 0.08 |

TABLE 2
Composition of Sulfamate Bath and Content of Sulfur,
Carbon, Phosphorus, Boron and Manganese of Belt Body

| | | Composition of Sulfamate Bath ¹⁾ | | | | | | Content of Sulfur, Carbon, | | | | |
|---|---|---|---|---|---|---|---|---|---|---|---|---|
| | | Sodium | | | | Manganese | | Phosphorus, Boron and Manganese | | | | |
| | | Hypophosphite | | Trimethyl- | | Sulfamate | | | | Phospho- | | Manga- |
| Ex. | Remarks | Monohydrate | | amine Borane | | Tetrahydrate | | Sulfur | Carbon | rus | Boron | nese |
| 11 | The | 20 | mg/L | 0 | | 0 | | 0.0057 | 0.04 | 0.04 | 0 | 0 |
| 12 | invention | 40 | mg/L | 0 | | 0 | | 0.0057 | 0.04 | 0.08 | 0 | 0 |
| 13 | | 60 | mg/L | 0 | | 0 | | 0.0057 | 0.04 | 0.12 | 0 | 0 |
| 14 | | 190 | mg/L | 0 | | 0 | | — | — | 0.38 | 0 | 0 |
| 15 | | 0 | | 15 | mg/L | 0 | | 0.0053 | 0.04 | 0 | 0.006 | 0 |
| 16 | | 0 | | 30 | mg/L | 0 | | 0.0046 | 0.03 | 0 | 0.012 | 0 |
| 17 | | 0 | | 40 | mg/L | 0 | | 0.0046 | 0.03 | 0 | 0.016 | 0 |
| 18 | | 0 | | 0 | | 60 | mg/L | 0.0063 | 0.05 | 0 | 0 | 0.05 |
| 19 | | 0 | | 0 | | 180 | mg/L | 0.0069 | 0.04 | 0 | 0 | 0.13 |
| 20 | | 0 | | 0 | | 300 | mg/L | 0.0070 | 0.04 | 0 | 0 | 0.21 |

Note:
¹⁾ The sulfamate bath contained 500 g/L of nickel sulfamate tetrahydrate, 35 g/L of boric acid, 0.3 g/L of primary brightener, and 140 mg/L of secondary brightener.

Then, the average grain diameter before heating, the average grain diameter after heating at 250° C. for 2 hours, and the average grain diameter after heating at 300° C. for 2 hours were measured by means of an X-ray diffractometer “RINT-200” manufactured by Rigaku Denki K. K. and the diffraction data were obtained by means of an analytical software “JAD” (registered trade mark) in respect of the rear surface (111) crystallites, front surface (111) crystallites, rear surface (200) crystallites, and front surface (200) crystallites. Also, the change and the change ratio of the average grain diameter were calculated. Tables 3 to 10 show the results.

TABLE 3
Average Grain Diameter of Rear (111)
Crystallites and Change After Heating

| | Rear (111) Crystallites | | | | | | |
|---|---|---|---|---|---|---|---|
| | | | | Chang of Average grain diameter | | | |
| | Average grain diameter | | | After heating at | | After heating at | |
| | | After heating | | 250° C. | | 300° C. | |
| | Before | for 2 hrs. | | | Change | | Change |
| Ex. | heating | 250° C. | 300° C. | Change | ratio | Change | ratio |
| 1 | 231 Å | 549 Å | 632 Å | 318 Å | 138% | 401 Å | 174% |
| 2 | 214 Å | 478 Å | 631 Å | 264 Å | 123% | 417 Å | 195% |
| 3 | 213 Å | 465 Å | 603 Å | 252 Å | 118% | 390 Å | 183% |
| 4 | 204 Å | 432 Å | 574 Å | 228 Å | 112% | 370 Å | 181% |
| 5 | 194 Å | 420 Å | 608 Å | 226 Å | 116% | 414 Å | 213% |
| 6 | 192 Å | 390 Å | 594 Å | 198 Å | 103% | 402 Å | 209% |
| 7 | 187 Å | 375 Å | 598 Å | 188 Å | 101% | 411 Å | 220% |
| 8 | 187 Å | 374 Å | 554 Å | 187 Å | 100% | 367 Å | 196% |
| 9 | 185 Å | 373 Å | 582 Å | 188 Å | 102% | 397 Å | 215% |
| 10 | 185 Å | 380 Å | 594 Å | 195 Å | 105% | 409 Å | 221% |

TABLE 4
Average Grain Diameter of Rear (111) Crystallites and Change After Heating

| | Rear (111) Crystallites | | | | | | | | |
|---|---|---|---|---|---|---|---|---|---|
| | | | | Change of Average grain | | | | | |
| | Average grain | | | diameter | | | | | |
| | diameter | | | After heating | | | After heating | | |
| | | After heating | | at 250° C. | | | at 300° C. | | |
| | Before | for 2 hrs. | | | | Change | | | Change |
| Ex. | heating | 250° C. | 300° C. | Change | | ratio | Change | | ratio |
| 11 | 184 Å | 236 Å | 264 Å | 52 | Å | 28% | 80 | Å | 43% |
| 12 | 179 Å | 226 Å | 248 Å | 47 | Å | 26% | 69 | Å | 39% |
| 13 | 178 Å | 217 Å | 237 Å | 39 | Å | 22% | 59 | Å | 33% |
| 14 | 156 Å | 191 Å | 207 Å | 35 | Å | 22% | 51 | Å | 33% |
| 15 | 163 Å | 238 Å | 415 Å | 76 | Å | 47% | 252 | Å | 155% |
| 16 | 151 Å | 211 Å | 337 Å | 60 | Å | 40% | 186 | Å | 123% |
| 17 | 146 Å | 200 Å | 284 Å | 54 | Å | 37% | 138 | Å | 95% |
| 18 | 188 Å | 296 Å | 522 Å | 108 | Å | 57% | 334 | Å | 178% |
| 19 | 187 Å | 256 Å | 341 Å | 69 | Å | 37% | 154 | Å | 82% |
| 20 | 179 Å | 228 Å | 261 Å | 49 | Å | 27% | 82 | Å | 46% |

TABLE 5
Average Grain Diameter of Rear (200)
Crystallites and Change After Heating

| | Rear (200) Crystallites | | | | | | |
|---|---|---|---|---|---|---|---|
| | | | | Change of Average grain | | | |
| | | | | diameter | | | |
| | Average grain diameter | | | After heating | | After heating | |
| | | After heating | | at 250° C. | | at 300° C. | |
| | Before | for 2 hrs. | | | Change | | Change |
| Ex. | heating | 250° C. | 300° C. | Change | ratio | Change | ratio |
| 1 | 215 Å | 231 Å | 258 Å | 16 Å | 7% | 43 Å | 20% |
| 2 | 207 Å | 219 Å | 247 Å | 12 Å | 6% | 40 Å | 19% |
| 3 | 204 Å | 216 Å | 234 Å | 12 Å | 6% | 30 Å | 15% |
| 4 | 200 Å | 210 Å | 228 Å | 10 Å | 5% | 28 Å | 14% |
| 5 | 190 Å | 202 Å | 229 Å | 12 Å | 6% | 39 Å | 21% |
| 6 | 183 Å | 195 Å | 219 Å | 12 Å | 7% | 36 Å | 20% |
| 7 | 171 Å | 187 Å | 229 Å | 16 Å | 9% | 58 Å | 34% |
| 8 | 179 Å | 191 Å | 212 Å | 12 Å | 7% | 33 Å | 18% |
| 9 | 170 Å | 186 Å | 219 Å | 16 Å | 9% | 49 Å | 29% |
| 10 | 159 Å | 184 Å | 242 Å | 25 Å | 16% | 83 Å | 52% |

TABLE 6
Average Grain Diameter of Rear (200)
Crystallites and Change After Heating

| | Rear (200) Crystallites | | | | | | | | |
|---|---|---|---|---|---|---|---|---|---|
| | | | | Change of Average grain | | | | | |
| | Average grain | | | diameter | | | | | |
| | diameter | | | After heating | | | After heating | | |
| | | After heating | | at 250° C. | | | at 300° C. | | |
| | Before | for 2 hrs. | | | | Change | | | Change |
| Ex. | heating | 250° C. | 300° C. | Change | | ratio | Change | | ratio |
| 11 | 183 Å | 198 Å | 192 Å | 15 | Å | 8% | 9 | Å | 5% |
| 12 | 182 Å | 195 Å | 192 Å | 13 | Å | 7% | 10 | Å | 5% |
| 13 | 180 Å | 193 Å | 191 Å | 13 | Å | 7% | 11 | Å | 6% |
| 14 | 166 Å | 177 Å | 179 Å | 11 | Å | 7% | 13 | Å | 8% |
| 15 | 174 Å | 183 Å | 191 Å | 9 | Å | 5% | 17 | Å | 10% |
| 16 | 148 Å | 159 Å | 170 Å | 11 | Å | 7% | 22 | Å | 15% |
| 17 | 134 Å | 148 Å | 159 Å | 14 | Å | 10% | 25 | Å | 19% |
| 18 | 184 Å | 193 Å | 207 Å | 9 | Å | 5% | 23 | Å | 13% |
| 19 | 174 Å | 183 Å | 188 Å | 9 | Å | 5% | 14 | Å | 8% |
| 20 | 159 Å | 169 Å | 173 Å | 10 | Å | 6% | 14 | Å | 9% |

TABLE 7
Average Grain Diameter of Front (111)
Crystallites and Change After Heating

| | Front (111) Crystallites | | | | | | | |
|---|---|---|---|---|---|---|---|---|
| | Average grain | | | Change of Average grain diameter | | | | |
| | diameter | | | After heating | | After heating at | | |
| | | After heating | | at 250° C. | | 300° C. | | |
| | Before | for 2 hrs. | | | Change | | | Change |
| Ex. | heating | 250° C. | 300° C. | Change | ratio | Change | | ratio |
| 1 | 249 Å | 306 Å | 371 Å | 57 Å | 23% | 122 | Å | 49% |
| 2 | 245 Å | 291 Å | 348 Å | 46 Å | 19% | 103 | Å | 42% |
| 3 | 243 Å | 282 Å | 341 Å | 39 Å | 16% | 98 | Å | 40% |
| 4 | 245 Å | 294 Å | 365 Å | 49 Å | 20% | 120 | Å | 49% |
| 5 | 213 Å | 259 Å | 333 Å | 46 Å | 22% | 120 | Å | 56% |
| 6 | 212 Å | 240 Å | 314 Å | 28 Å | 13% | 102 | Å | 48% |
| 7 | 194 Å | 248 Å | 320 Å | 54 Å | 28% | 126 | Å | 65% |
| 8 | 201 Å | 256 Å | 305 Å | 55 Å | 27% | 104 | Å | 52% |
| 9 | 191 Å | 246 Å | 290 Å | 55 Å | 29% | 99 | Å | 52% |
| 10 | 175 Å | 235 Å | 433 Å | 60 Å | 34% | 258 | Å | 147% |

TABLE 8
Average Grain Diameter of Front (111)
Crystallites and Change After Heating

| | Front (111) Crystallites | | | | | | |
|---|---|---|---|---|---|---|---|
| | | | | Change of Average grain | | | |
| | Average grain | | | diameter | | | |
| | diameter | | | After heating | | After heating at | |
| | | After heating | | at 250° C. | | 300° C. | |
| | Before | for 2 hrs. | | | Change | | Change |
| Ex. | heating | 250° C. | 300° C. | Change | ratio | Change | ratio |
| 11 | 206 Å | 248 Å | 267 Å | 42 Å | 20% | 61 Å | 30% |
| 12 | 200 Å | 239 Å | 251 Å | 39 Å | 20% | 51 Å | 26% |
| 13 | 196 Å | 221 Å | 251 Å | 25 Å | 13% | 55 Å | 28% |
| 14 | 169 Å | 204 Å | 218 Å | 35 Å | 21% | 49 Å | 29% |
| 15 | 180 Å | 232 Å | 262 Å | 52 Å | 29% | 82 Å | 56% |
| 16 | 154 Å | 198 Å | 227 Å | 44 Å | 29% | 73 Å | 47% |
| 17 | 148 Å | 194 Å | 225 Å | 46 Å | 31% | 77 Å | 52% |
| 18 | 192 Å | 253 Å | 272 Å | 61 Å | 32% | 80 Å | 42% |
| 19 | 194 Å | 230 Å | 256 Å | 36 Å | 19% | 62 Å | 32% |
| 20 | 180 Å | 220 Å | 227 Å | 40 Å | 22% | 47 Å | 26% |

TABLE 9
Average Grain Diameter of Front (200)
Crystallites and Change After Heating

| | Front (200) Crystallites | | | | | | | | |
|---|---|---|---|---|---|---|---|---|---|
| | | | | Change of Average grain | | | | | |
| | Average grain | | | diameter | | | | | |
| | diameter | | | After heating | | | After heating | | |
| | | After heating | | at 250° C. | | | at 300° C. | | |
| | Before | for 2 hrs. | | | | Change | | | Change |
| Ex. | heating | 250° C. | 300° C. | Change | | ratio | Change | | ratio |
| 1 | 231 Å | 233 Å | 237 Å | 2 | Å | 1% | 6 | Å | 3% |
| 2 | 220 Å | 221 Å | 224 Å | 1 | Å | 1% | 4 | Å | 2% |
| 3 | 209 Å | 210 Å | 212 Å | 1 | Å | 1% | 3 | Å | 1% |
| 4 | 204 Å | 204 Å | 205 Å | 0 | | 0% | 1 | Å | 1% |
| 5 | 201 Å | 204 Å | 207 Å | 3 | Å | 2% | 6 | Å | 3% |
| 6 | 194 Å | 196 Å | 196 Å | 2 | Å | 1% | 2 | Å | 1% |
| 7 | 180 Å | 184 Å | 186 Å | 4 | Å | 2% | 6 | Å | 3% |
| 8 | 204 Å | 195 Å | 209 Å | −9 | Å | — | 5 | Å | 2% |
| 9 | 192 Å | 186 Å | 200 Å | −6 | Å | — | 8 | Å | 4% |
| 10 | 164 Å | 172 Å | 191 Å | 8 | Å | 5% | 27 | Å | 16% |

TABLE 10
Average Grain Diameter of Front (200)
Crystallites and Change After Heating

| | Front (200) Crystallites | | | | | | | | |
|---|---|---|---|---|---|---|---|---|---|
| | | | | Change of Average grain | | | | | |
| | Average grain | | | diameter | | | | | |
| | diameter | | | After heating | | | After heating | | |
| | | After heating | | at 250° C. | | | at 300° C. | | |
| | Before | for 2 hrs. | | | | Change | | | Change |
| Ex. | heating | 250° C. | 300° C. | Change | | ratio | Change | | ratio |
| 11 | 198 Å | 208 Å | 204 Å | 10 | Å | 5% | 6 | Å | 3% |
| 12 | 199 Å | 204 Å | 202 Å | 5 | Å | 3% | 3 | Å | 2% |
| 13 | 198 Å | 204 Å | 203 Å | 6 | Å | 3% | 5 | Å | 3% |
| 14 | 192 Å | 198 Å | 199 Å | 6 | Å | 3% | 7 | Å | 4% |
| 15 | 194 Å | 197 Å | 198 Å | 3 | Å | 2% | 4 | Å | 2% |
| 16 | 172 Å | 175 Å | 178 Å | 3 | Å | 2% | 6 | Å | 3% |
| 17 | 149 Å | 155 Å | 159 Å | 6 | Å | 4% | 10 | Å | 7% |
| 18 | 195 Å | 197 Å | 200 Å | 2 | Å | 1% | 5 | Å | 3% |
| 19 | 186 Å | 190 Å | 195 Å | 4 | Å | 2% | 9 | Å | 5% |
| 20 | 164 Å | 173 Å | 177 Å | 9 | Å | 5% | 13 | Å | 8% |

As is apparent from the data given in Tables 3 to 10, the crystallites constituting the electroformed nickel belt body in Examples 1 to 20 were found to have an average grain diameter of 130 to 250 Å. Also, the data support that the rear surface (111) crystallites have the largest change and the highest change ratio of the average grain diameter between the state before heating and the state after heating among the crystallites constituting the electroformed nickel belt body, i.e., among the rear surface (111) crystallites, front surface (111) crystallites, surface (200) crystallites, and rear surface (200) crystallites.

<Thermal Fatigue Test>

A test piece of shape 13B stipulated in JIS Z2201 was cut out of the belt body obtained in each of Examples 1 to 20, and the test piece thus prepared was subjected to a thermal fatigue test under the conditions given below by means of an INSTRON 8871 system manufactured by INSTRON Inc.:
Repeated Maximum Tension: 550 N/mm²
Repeated Minimum Tension: about 80 N/mm²
Ambient Temperature: 250° C.
Repeating Period: 15 Hz

The thermal fatigue test was continued until the test piece was broken so as to record the number of repetitions of the test. Incidentally, the upper limit in the number of repetitions of the test was set at 1,000,000. Table 11 shows the result of the test. The mark “x” shown in Table 11 denotes the evaluation that the number of repetitions of the thermal fatigue test was smaller than 300,000, the mark “◯” denotes the evaluation that the number of repetitions of the thermal fatigue was not smaller than 300,000, and the mark “\mathring{∘}” denotes the evaluation that the test piece was not broken even if the number of repetitions of the thermal fatigue test reached 1,000,000.

The thermal fatigue test was applied similarly, with the repeated maximum tension changed to 650 N/mm², to the belt bodies of Examples 6 and 9 and to the belt bodies of Examples 11, 13 and 14 containing phosphorus. The belt bodies of Examples 11, 13 and 14 were selected as representatives of belt bodies containing the crystal growth suppressing agent. Also, the belt bodies of Examples 6, 9, 11, 13 and 14 were selected from among the belt bodies that received the evaluation of “\mathring{∘}”. Table 11 also the result of the evaluation.

TABLE 11
Result of Thermal Fatigue Test

| | Maximum Tension: 550 N/mm² | | Maximum Tension: 650 N/mm² | |
|---|---|---|---|---|
| | Number of | | Number of | |
| Ex. | Repetitions | Evaluation | Repetitions | Evaluation |
| 1 | 51,200 | X | — | — |
| 2 | 99,400 | X | — | — |
| 3 | 141,400 | X | — | — |
| 4 | 231,200 | X | — | — |
| 5 | 262,400 | X | — | — |
| 6 | >1,000,000 | ⊚ | 99,000 | X |
| 7 | >1,000,000 | ⊚ | — | — |
| 8 | >1,000,000 | ⊚ | — | — |
| 9 | >1,000,000 | ⊚ | 113,200 | X |
| 10 | 570,600 | ◯ | — | — |
| 11 | >1,000,000 | ⊚ | >1,000,000 | ⊚ |
| 12 | >1,000,000 | ⊚ | — | — |
| 13 | >1,000,000 | ⊚ | >1,000,000 | ⊚ |
| 14 | >1,000,000 | ⊚ | >1,000,000 | ⊚ |
| 15 | >1,000,000 | ⊚ | — | — |
| 16 | >1,000,000 | ⊚ | — | — |
| 17 | >1,000,000 | ⊚ | — | — |
| 18 | >1,000,000 | ⊚ | — | — |
| 19 | >1,000,000 | ⊚ | — | — |
| 20 | >1,000,000 | ⊚ | — | — |

As is apparent from the data under the maximum tension of 550 N/mm² shown in Table 11, the number of repetitions of the thermal fatigue test for the belt bodies of Examples 6 to 20 far exceeded 300,000 and reached a level not smaller than 500,000, and almost of the belt bodies of Examples 6 to 20 were not broken even if the number of repetitions of the thermal fatigue test reached 1,000,000. The belt bodies of Examples 6 to 20 had the rear surface (111) crystallites, in which the change ratio of the average grain diameter after heating at 250° C. for 2 hours was not larger than 110% and also the change in the average grain diameter between the state before heating and the state after heating was not larger than 220 Å, particularly, not larger than 200 Å. When it comes to the belt bodies of Examples 11 to 20 containing a crystal growth suppressing agent, which were not broken even if the thermal fatigue test was repeated 1,000,000 times, the change ratio of the average grain diameter of the rear surface (111) crystallites between the state before heating and the state after heating was not larger than 60%, and the change in the average grain diameter between the state before heating and the state after heating was not larger than 110 Å (see Table 4).

Also, as is apparent from the data shown in Table 11, which covers the case where the thermal fatigue test was conducted under the maximum tension of 650 N/mm², the electroformed nickel belt body and containing a crystal growth suppressing agent was found to exhibit a marked improvement in thermal fatigue resistance properties, compared with the electroformed nickel belt body not containing a crystal growth suppressing agent.

1. A fixing belt for fixing a toner image on a transfer medium, comprising an endless belt body formed of electroformed nickel comprising crystallites oriented on crystal orientation planes, wherein, with respect to those crystallites on the crystal plain which have average grain diameter greatly changed by heating, a change ratio of average grain diameter after heating at 250° C. for 2 hours is not larger than 110% based on average grain diameter before heating.

2. The toner fixing belt according to claim 1, wherein the crystallites having a great change in average grain diameter and oriented on the crystal orienting plane have a change ratio not larger than 60% in average grain diameter after heating at 250° C. for 2 hours based on the average grain diameter before heating.

3. The toner fixing belt according to claim 1, wherein the crystallites having a great change in the average grain diameter and oriented on the crystal orienting plane have a difference not larger than 220 Å in average grain diameter between the state after heating at 250° C. for 2 hours and the state before heating.

4. The toner fixing belt according to claim 1, wherein the crystallites having a great change in average grain diameter and oriented on the crystal orienting plane are formed of the crystallites oriented on the (111) plane on the rear surface of the belt body.

5. The toner fixing belt according to claim 1, wherein the belt body is formed of crystallites having an average grain diameter of 130 Å to 250 Å in an unheated state.

6. The toner fixing belt according to claim 1, wherein the belt body contains at least one crystal growth suppressing agent selected from the group consisting of phosphorus, boron and manganese.

7. The toner fixing belt according to claim 6, wherein phosphorus is used as the crystal growth suppressing agent, and the belt body contains phosphorus in an amount not smaller than 0.04 mass % but smaller than 0.4 mass %.

8. The toner fixing belt according to claim 6, wherein boron is used as the crystal growth suppressing agent, and the belt body contains boron in an amount of 0.001 to 0.02 mass %.

9. The toner fixing belt according to claim 6, wherein manganese is used as the crystal growth suppressing agent, and the belt body contains manganese in an amount of 0.04% to 0.5 mass %.

10. A fixing belt for fixing a toner image on a transfer medium, comprising an endless belt body formed of electroformed nickel comprising crystallites oriented on crystal orientation planes, wherein, with respect to those crystallites on the crystal orientation plain which have average grain diameter greatly changed by heating, a difference in average grain diameter after heating at 250° C. for 2 hours and that before heating is suppressed to 220 Å or less.

11. The toner fixing belt according to claim 10, wherein the crystallites having a great change in average grain diameter and oriented on the crystal orienting plane have a difference not larger than 200 Å in average grain diameter between the state after heating at 250° C. for 2 hours and the state before heating.

12. The toner fixing belt according to claim 10, wherein the crystallites having a great change in average grain diameter and oriented on the crystal orienting plane have a difference not larger than 110 Å in average grain diameter between the state after heating at 250° C. for 2 hours and the state before heating.

13. The toner fixing belt according to claim 10, wherein the crystallites having a great change in average grain diameter and oriented on the crystal orienting plane are formed of the crystallites oriented on the (111) plane on the rear surface of the belt body.

14. The toner fixing belt according to claim 10, wherein the belt body is formed of crystallites having an average grain diameter of 130 Å to 250 Å in an unheated state.

15. The toner fixing belt according to claim 10, wherein the belt body contains at least one crystal growth suppressing agent selected from the group consisting of phosphorus, boron and manganese.

16. The toner fixing belt according to claim 15, wherein phosphorus is used as the crystal growth suppressing agent, and the belt body contains phosphorus in an amount not smaller than 0.04 mass % but smaller than 0.4 mass %.

17. The toner fixing belt according to claim 15, wherein boron is used as the crystal growth suppressing agent, and the belt body contains boron in an amount of 0.001 to 0.02 mass %.

18. The toner fixing belt according to claim 15, wherein manganese is used as the crystal growth suppressing agent, and the belt body contains manganese in an amount of 0.04% to 0.5 mass %.
